(19) United States
(12) Patent Application Publication
(10) Pub. No.: US 2024/0332510 A1
(43) Pub. Date: Oct. 3, 2024

(54) NEGATIVE ELECTRODE SHEET AND LITHIUM-ION BATTERY

(71) Applicant: ZHUHAI COSMX BATTERY CO., LTD., Zhuhai (CN)

(72) Inventors: Baohai ZHANG, Zhuhai (CN); Chong PENG, Zhuhai (CN); Junyi LI, Zhuhai (CN)

(21) Appl. No.: 18/737,891

(22) Filed: Jun. 7, 2024

Related U.S. Application Data
(63) Continuation of application No. PCT/CN2023/086614, filed on Apr. 6, 2023.

(30) Foreign Application Priority Data
Apr. 7, 2022 (CN) 202210360401.2

(51) Int. Cl. H01M 4/36; H01M 4/02; H01M 4/133; H01M 4/587; H01M 10/0525

(52) U.S. Cl. CPC H01M 4/366; H01M 4/133; H01M 4/587; H01M 10/0525; H01M 2004/021; H01M 2004/027

(57) ABSTRACT

A negative electrode sheet, including a negative current collector, where a first negative electrode film layer is attached to a surface of the negative current collector, and an active substance of the first negative electrode film layer includes silicon particles and first graphite particles; a second negative electrode film layer is attached to a surface of the first negative electrode film layer, and an active substance of the second negative electrode film layer includes second graphite particles. That is, a negative electrode film layer is divided into two layers, such that when lithium-ions move to the negative electrode sheet, part of lithium-ions are first embedded into the second negative electrode film layer, and the remaining lithium-ions are embedded into the first negative electrode film layer.

### CROSS-REFERENCE TO RELATED APPLICATION

This present application is a continuation of International Application No. PCT/CN2023/086614, filed on Apr. 6, 2023, which claims priority to Chinese Patent Application Ser. No. 202210360401.2 filed on Apr. 7, 2022. The disclosures of the aforementioned application are hereby incorporated by reference in their entireties.

### TECHNICAL FIELD

The present disclosure relates to the field of battery technology, and in particular, a negative electrode sheet and a lithium-ion battery.

### BACKGROUND

In recent years, with the explosive growth of sales of portable electronic product, the lithium-ion batteries have become the power source for various devices. In related technologies, the lithium-ion battery includes a positive electrode sheet, a negative electrode sheet, a separator and an electrolyte solution, and the negative electrode sheet includes a metal sheet and a functional layer covered on the metal sheet, where the functional layer is formed from graphite particles and silicon particles by mixing.

However, in the charging and discharging process of lithium-ion battery, due to the difference in the conductivity and lithium storage amount between silicon particles and graphite particles, there is the difference in the potential and polarization degree between two materials during charging, thereby resulting in the lithium precipitation phenomenon of functional layer in which graphite particles and silicon particles are mixed, and thus affecting the endurance and service life of lithium-ion battery.

### SUMMARY

An embodiment of the present disclosure provides a negative electrode sheet and a lithium-ion battery, for solving the problem in the related technologies that a lithium precipitation phenomenon is easy to occur in a functional layer in which graphite particles and silicon particles are mixed, thereby affecting the endurance and service life of lithium-ion battery.

The solution to solve the above technical problem in an embodiment of the present disclosure is as follows.

A negative electrode sheet, includes:
a negative current collector;
a first negative electrode film layer attached to a surface of the negative current collector, an active substance of the first negative electrode film layer including silicon particles and first graphite particles;
a second negative electrode film layer attached to a surface of the first negative electrode film layer, an active substance of the second negative electrode film layer including second graphite particles, and a particle size of the second graphite particle being greater than a particle size of the first graphite particle.

Beneficial effects of an embodiment of the present disclosure are as follows. The first negative electrode film layer and the second negative electrode film layer are disposed successively on the surface of the negative current collector, that is, the first negative electrode film layer is attached to the surface of the negative current collector, the second negative electrode film layer is attached to the surface of the first negative electrode film layer, the active substance of the first negative electrode film layer includes the silicon particles and the first graphite particles, and the active substance of the second negative electrode film layer includes the second graphite particles. That is, the negative electrode film layer is divided into two layers, where the active substance of the negative electrode film layer close to the negative current collector includes a mixture of the silicon particles and the graphite particles, and the active substance of another negative electrode film layer far away from the negative current collector includes the graphite particles. In this way, when the lithium-ions move to the negative electrode sheet, part of the lithium-ions are first embedded into the graphite particles in the second negative electrode film layer, and the remaining lithium-ions are embedded into the first negative electrode film layer. Since part of lithium-ions are first embedded into the second negative electrode film layer, the concentration of lithium-ions moving to the first negative electrode film layer is reduced and the speed thereof becomes slow, so that there will be sufficient time for lithium-ions to get embedded into the silicon particles and the first graphite particles, thereby reducing the accumulation of lithium-ions at the silicon particle and the nearby first graphite particles, and relieving the phenomenon of uneven distribution of lithium-ion concentration, namely, reducing the lithium precipitation. At the same time, since the particle size of the first graphite particle is smaller than the particle size of the second graphite particle, that is, the particle size of the first graphite particle is smaller, by using the first graphite particle with a smaller particle size, a periphery of the silicon particle can be wrapped with more first graphite particles, thereby improving the dynamic performance of silicon particles more effectively. In addition, by using the second graphite particle with a larger particle size, on the one hand, the larger particle size can improve compaction; on the other hand, there are more gaps between the second graphite particles with the larger particle size, which can improve the porosity of the negative electrode sheet compared with the graphite particle having smaller particle size, and then improve the liquid retention of the battery cell, reduce the surface polarization of the negative electrode sheet, and improve the dynamic performance of the negative electrode sheet. Therefore, the endurance and service life of lithium-ion battery can be effectively improved by using the above structure.

On the basis of the above technical solutions, an embodiment of the present disclosure can further be improved as follows.

In a possible implementation, a particle size of the first graphite particle is smaller than a particle size of the silicon particle.

In a possible implementation, the first graphite particle and the second graphite particle are each obtained from a same type of graphite by sieving.

In a possible implementation, in the first negative electrode film layer, a D50 particle size of the silicon particle is 6 μm-10 μm, and a D90 particle size of the silicon particle is 18 μm-22 μm; and a D50 particle size of the first graphite particle is 2 μm-4.5 μm, and a D90 particle size of the first graphite particle is 4.7 μm-6 μm.

In a possible implementation, in the second negative electrode film layer, a D50 particle size of the second graphite particle is 11 μm-14 μm, and a D90 particle size of the second graphite particle is 22 μm-29 μm.

In a possible implementation, the particle size of the second graphite particle is greater than 7 μm.

In a possible implementation, a ratio of a thickness of the first negative electrode film layer to a thickness of the second negative electrode film layer is 1:9-9:1.

In a possible implementation, a lithium-ion battery includes a positive electrode sheet, a negative electrode sheet, a separator and an electrolyte solution, and the negative electrode sheet is the negative electrode sheet of any of the above.

A method for preparing a negative electrode sheet, including:
obtaining first graphite particles, silicon particles and second graphite particles, and mixing the first graphite particles with the silicon particles to form a mixed material;
uniformly mixing the mixed material, a first conductive agent, a first binder and a first thickener to obtain a slurry of the first negative electrode film layer;
uniformly mixing the second graphite particles, a second conductive agent, a second binder and a second thickener to obtain a slurry of the second negative electrode film layer;
coating the slurry of the first negative electrode film layer on a surface of the negative current collector, and coating the slurry of the second negative electrode film layer on a surface of the first negative electrode film layer;
drying the negative current collector coated with the slurry of the first negative electrode film layer and the slurry of the second negative electrode film layer.

In a possible implementation, the obtaining first graphite particles, silicon particles and second graphite particles, and mixing the first graphite particles with the silicon particles to form a mixed material, includes:
obtaining a certain amount of same kind of graphite particles, screening the graphite particles, where the graphite particles having a particle size of less than a preset range act as the first graphite particles, and the remaining graphite particles act as the second graphite particles.

### BRIEF DESCRIPTION OF DRAWINGS

FIG. 1 is a schematic diagram of a first negative electrode film layer and a second negative electrode film layer in a negative electrode sheet provided by an embodiment of the present disclosure.

FIG. 2 is a structural schematic diagram of a first graphite particle, a silicon particle, a mixed material and a second graphite particle provided by an embodiment of the present disclosure.

FIG. 3 is a flow chart of a method of preparing the negative electrode sheet provided by an embodiment of the present disclosure.

### DESCRIPTION OF REFERENCE NUMBERS

100, negative current collector; 200, first negative electrode film layer; 210, first graphite particle; 220, silicon particle; 230, mixed material; 300, second negative electrode film layer; 310, second graphite particle.

### DESCRIPTION OF EMBODIMENTS

In recent years, with the explosive growth of sales of portable electronic product, lithium-ion batteries have become the power source for various devices. People's performance requirements for the lithium-ion batteries have also been further improved, and the demand for lithium-ion batteries to have a longer life is an important indicator of the lithium-ion batteries.

In related technologies, the lithium-ion battery includes a positive electrode sheet, a negative electrode sheet, a separator and an electrolyte solution; the negative electrode sheet includes a metal sheet and a functional layer covered on the metal sheet. In order to improve the energy density of lithium-ion battery, the functional layer is formed from graphite and silicon by mixing, thus being capable to improve the energy density of lithium-ion battery due to the lithium storage amount of silicon being much greater than that of graphite, thereby improving the endurance and service life of lithium-ion battery.

However, in the charging and discharging process of lithium-ion battery, due to the difference in the conductivity and lithium storage amount between silicon and silicon oxide materials and graphite materials, there is the difference in the potential and polarization degree of two kinds of materials during charging, which makes a potential of silicon particles high, and a potential of graphite particles near the silicon particles lowest, resulting in the uneven distribution of lithium-ion concentration in the negative electrode sheet and accordingly the phenomenon of lithium precipitation. At the same time, due to the volume of silicon particle being easy to expand in the charging and discharging process, the structure of the electrode material is easy to collapse and subjected to particle differentiation during a cycle, thereby resulting in the loss of electronic conductivity between the active substances and between the active substance and the current collector. Due to the poor conductivity of the silicon particle itself, it leads to irreversible capacity loss, thereby affecting the endurance and cycle life of lithium-ion battery.

Accordingly, an embodiment of the present disclosure provides a negative electrode sheet, including a negative current collector, where a first negative electrode film layer and a second negative electrode film layer are disposed successively on a surface of the negative current collector. That is, the first negative electrode film layer is attached to the surface of the negative current collector, and the second negative electrode film layer is attached to a surface of the first negative electrode film layer. An active substance of the first negative electrode film layer includes silicon particles and first graphite particles, and an active substance of the second negative electrode film layer includes second graphite particles, that is, a negative electrode film layer is divided into two layers, where the active substance of the negative electrode film layer close to the negative current collector includes a mixture of the silicon particles and the first graphite particles; and the active substance of another negative electrode film layer away from the negative current collector includes second graphite particles. In this way, when the lithium-ions move to the negative electrode sheet, part of the lithium-ions are first embedded into the graphite particles in the second negative electrode film layer, and the remaining lithium-ions are embedded into the first negative electrode film layer. Since part of lithium-ions are first embedded into the second negative electrode film layer, the concentration of lithium-ions moving to the first negative electrode film layer is reduced and the speed of such lithium-ion becomes slow, so that there will be enough time for lithium-ions to get embedded into the silicon particles and the first graphite particles, thus reducing the accumulation of lithium-ions at the silicon particles and nearby first graphite particles, and relieving the phenomenon of uneven distribution of lithium-ion concentration, namely, reducing the lithium precipitation. At the same time, since the particle size of the first graphite particle is smaller than the particle size of the second graphite particle, that is, the particle size of the first graphite particle is smaller, using the first graphite particle with a small particle size can make the periphery of the silicon particle wrapped with more first graphite particles, thereby improving the dynamic performance of silicon particles more effectively. In addition, selecting the second graphite particle with a larger particle size, on the one hand, can improve the compaction, and on the other hand, can form more gaps between the second graphite particles with the larger particle size, which can improve the porosity of the negative electrode sheet compared with the graphite particle with a small particle size, and then improve the liquid retention of the battery cell, reduce the surface polarization of the negative electrode sheet, and enhance the dynamic performance of the negative electrode sheet. Therefore, the endurance and service life of lithium-ion battery can be effectively improved by using the above structure.

In order to make the above purposes, characteristics and advantages of embodiments of the present application more obvious and understandable, the following clearly and comprehensively describes the technical solutions in embodiments of the present application with reference to the accompanying drawings in embodiments of the present application. Apparently, the described embodiments are merely a part rather than all embodiments of the present application. All other embodiments obtained by persons of ordinary skill in the art based on embodiments of the present application without creative effort shall fall within the protection scope of the present application.

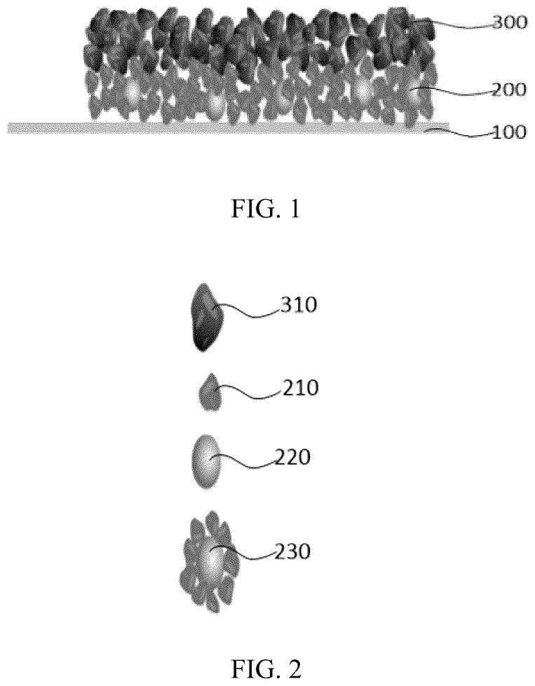

Referring to FIGS. 1 and 2, an embodiment of present disclosure provides a negative electrode sheet, including a negative current collector 100, a first negative electrode film layer 200 is attached to a surface of a negative current collector 100; and an active substance of the first negative electrode film layer 200 includes silicon particles 220 and first graphite particles 210; a second negative electrode film layer 300 is attached to a surface of the first negative electrode film layer 200, and an active substance of the second negative electrode film layer 300 includes second graphite particles 310.

Where, the negative current collector 100 may be a copper foil, which mainly plays a conductive role and acts as a carrier of the negative electrode film layer, and a thickness of the copper foil may be 4-15 μm. For example, a thickness of the copper foil may be 4 μm, 7 μm, 11 μm or 15 μm. Where, the copper foil may be one of a homogeneous copper foil, a porous copper foil, or a copper foil with a carbon coating.

Exemplarily, the first negative electrode film layer 200 may be a film layer obtained by coating a slurry of the first negative electrode film layer 200 on a surface of the negative current collector 100 and drying them. Where, the slurry of the first negative electrode film layer 200 may include deionized water, that is, the silicon particles 220 and the first graphite particles 210 are evenly mixed by the deionized water to form a slurry, and the slurry is coated on the copper foil, thereby forming the first negative electrode film layer 200 that has mixed active substances of silicon particles 220 and the first graphite particles 210.

Exemplarily, the second negative electrode film layer 300 may be a film layer obtained by coating a slurry of the second negative electrode film layer 300 on a surface of the first negative electrode film layer 200 and drying them. Where, the slurry of first negative electrode film layer 200 may include deionized water, that is, the second graphite particles 310 are formed into a slurry by the deionized water, and the slurry is coated on a copper foil, thereby forming the second negative electrode film layer 300 that has an active substance of the second graphite particles 310.

Exemplarily, the first graphite particle 210 and the second graphite particle 310 may each include one or more of artificial graphite, natural graphite, mesophase carbon microsphere, soft carbon, hard carbon, and organic polymer compound carbon. The silicon particle 220 may include one or more of silicon oxide material, silicon carbide material, and nano-silicon material.

For the negative electrode sheet provided in this embodiment, the negative electrode film layer is divided into two layers, where the active substance of the negative electrode film layer close to the negative current collector 100 includes a mixture of the silicon particle 200 and the graphite particle. The active substance of another negative electrode film layer away from the negative current collector 100 includes the graphite particle. Accordingly, when the lithium-ions move to the negative electrode sheet, part of the lithium-ions are first embedded into the graphite particles in the second negative electrode film layer 300, and the remaining lithium-ions are embedded into the first negative electrode film layer 200. Since part of lithium-ions are first embedded into the second negative electrode film layer 300, the concentration of lithium-ions moving to the first negative electrode film layer 200 is reduced and the speed of them becomes slow, so that there will be enough time for lithium-ions to get embedded into the silicon particles and the first graphite particles, thus reducing the accumulation of lithium-ions at the silicon particles 200 and nearby graphite particles, and relieving the phenomenon of uneven distribution of lithium-ion concentration. That is, the lithium precipitation is reduced, thereby improving the endurance and service life of the lithium-ion battery.

Continuing to refer to FIGS. 1 and 2, a particle size of the first graphite particle 210 is smaller than a particle size of silicon particle 220.

Exemplarily, a periphery of the silicon particle 220 may be completely wrapped by the first graphite particles 210, that is, the first graphite particles 210 surround the silicon particle 220 and are attached to the periphery of the silicon particle 220. For example, a ratio of D90 of the first graphite particle 210 to D90 of the silicon particle 220 may be in a range of 0.2-0.5. Where, the ratio of D90 of the first graphite particle 210 to D90 of the silicon particle 220 may be 0.2, 0.3 or 0.5, so that the particle size of the first graphite particle 210 may be much less than the particle size of the silicon particle 220.

Exemplarily, a D50 particle size of the silicon particle 220 is in a range of 6 μm-10 μm, and a D90 particle size of the silicon particle 220 is in a range of 18 μm-22 μm. For example, the D50 of the silicon particle 220 may be 6 μm, 8 μm, or 10 μm; the D90 of the silicon particle 220 may be 18 μm, 20 μm, or 22 μm. A D50 particle size of the first graphite particle 210 is in a range of 2 μm-4.5 μm, and a D90 particle size of the first graphite particle 210 is in a range of 4.7 μm-6 μm. For example, the D50 particle size of the first graphite particle 210 may be 2 μm, 3 μm or 4.5 μm; the D90 particle size of the first graphite particle 210 may be 4.7 μm, 5.5 μm, or 6 μm.

Where, D50 refers to a particle size when the cumulative distribution of particle is 50%, also known as a median diameter or a median particle size. This is a typical value that represents granularity size, and the value accurately bisects the population of particles, that is, 50% of the particles exceed this value, and 50% of the particles are below this value. If D50 of a sample is equal to 6 μm, it is showed that in all the particles that make up the sample, the particles larger than 6 μm account for 50% and the particles smaller than 6 μm also account for 50%.

D90 refers to a particle size when the cumulative distribution of particle is 90%, that is, the volume content of particles less than this particle size accounts for 90% of all particles.

In this embodiment, the combination of large-particle-size silicon particle 220 and small-particle-size graphite particle mainly serves to further improve the dynamic performance of the negative electrode sheet. This is because that the dynamic performance of the silicon particle 220 is poor, especially the silicon particle 220 of D90, its particle size is large and its dynamic performance is poor. Therefore, using the first graphite particles 210 to wrap around D90 silicon particle 220 can effectively enhance the dynamic performance of silicon particle 220 and improve the situation of lithium precipitation around silicon particle 220, thereby being capable of effectively increasing the charging speed of lithium-ion battery. At the same time, using small-particle-size first graphite particle 210 can make the periphery of silicon particle 220 wrapped with more first graphite particles 210, thereby being capable of improving the dynamic performance of silicon particle 220 more effectively. In other words, since the dynamic performance of the first graphite particle 210 is obviously better than that of the silicon particle 220, the lithium-ions surrounding the silicon particle 220 can be quickly embedded into the first graphite particles 210, thus effectively improving the situation of lithium precipitation around the silicon particle 220. That is, the dynamic performance of the negative electrode plate is effectively improved, which is capable of increasing effectively the endurance and service life of lithium-ion battery.

In some embodiments, in the first negative electrode film layer 200, a content of the silicon particle 220 may be 0.1%-30%. Exemplarily, the content of the silicon particle 220 may be 0.1%, 5%, 10%, 20% or 30%, and its specific content may be set according to the actual situation.

In addition, the first negative electrode film layer 200 may further include a first conductive agent, a first binder and a first thickener; and the mass ratio of a mixed material 230, the first conductive agent, the first binder and the first thickener is 75 wt %-99 wt %:0.1 wt %-5 wt %:0.1 wt %-5 wt %:0.5 wt %-5 wt %. Exemplarily, the mass ratio of the mixed material 230, the first conductive agent, the first binder and the first thickener may be 75 wt %:0.1 wt %:0.1 wt %:0.5 wt %; 85 wt %:2 wt %:3 wt %:2.5 wt %; 96.9 wt %:0.5 wt %:1.3 wt %:1.3 wt %; or 99 wt %:5 wt %:5 wt %:5 wt %.

Exemplarily, the first conductive agent may be one or more of conductive carbon black, carbon fiber, Ketjen black, acetylene black, carbon nanotube, and graphene.

The first thickener may be sodium carboxymethyl cellulose or lithium carboxymethyl cellulose.

The first binder may be a water-based binder, for example, it may be one or more of styrene butadiene rubber, nitrile butadiene rubber, butadiene rubber, modified styrene butadiene rubber, sodium polyacrylate, water-based polyacrylonitrile copolymer or polyacrylate.

In some embodiments, the first graphite particle 210 and the second graphite particle 310 are obtained from the same kind of graphite by sieving, and the particle size of the first graphite particle 210 may be smaller than the particle size of the second graphite particle 310.

Exemplarily, in the second negative electrode film layer 300, a D50 particle size of the second graphite particle 310 is in a range of 11 μm-14 μm, and a D90 particle size of the second graphite particle is in a range of 22 μm-29 μm.

It can be understood that the first graphite particle 210 and the second graphite particle 310 are derived from the same kind of graphite, where the D10 particles are screened out from the graphite particle, and this part of the graphite particles serves as the first graphite particles 210, and the remaining graphite particles serve as the second graphite particles 310. Further, in some embodiments, the particle sizes of the second graphite particles 310 are each greater than 7 μm, that is, after the D10 particles in the graphite particles are screened out, the remaining graphite particles where the graphite particles of a particle size less than 7 μm are removed act as the second graphite particles 310. By selecting the second graphite particle 310 as larger particle, on the one hand, the larger particle can improve the compaction; on the other hand, there are more gaps between the second graphite particles as the larger particles, which can improve the porosity of the negative electrode sheet compared with the graphite particle as smaller particle, and then enhance the liquid retention of the battery cell, reduce the surface polarization of the negative electrode sheet, and improve the dynamic performance of the negative electrode sheet, thereby further increasing the endurance and service life of lithium-ion battery. Meantime, the reason of selecting the same kind of graphite for the first graphite particle 210 and the second graphite particle 310 lies in that the material texture of graphite is similar, the physical and chemical parameters are the same, and accordingly the transmission resistance of lithium-ions in the graphite material is the same. At the same time, the same kind of graphite is selected to make the compaction parameters of the material similar during rolling, resulting in a tight contact between two layers of graphite particles, and thus avoiding delamination.

In addition, the second negative electrode film layer 300 further includes a second conductive agent, a second binder and a second thickener, and the mass ratio of the second graphite particle 310, the second conductive agent, the second binder and the second thickener is 75 wt %-99 wt %:0.1 wt %-5 wt %:0.1 wt %-5 wt %:0.5 wt %-5 wt %. Exemplarily, the mass ratio of the second graphite particle 310, the second conductive agent, the second binder and the second thickener may be 75 wt %:0.1 wt %:0.1 wt %:0.5 wt %; 85 wt %:2 wt %:3 wt %:2.52 wt %; 96.9 wt %:0.5 wt %:1.3 wt %:1.3 wt %; or 99 wt %:5 wt %:5 wt %:5 wt %.

Exemplarily, the second conductive agent may be one or more of conductive carbon black, carbon fiber, Ketjen black, acetylene black, carbon nanotubes, and graphene.

The second thickener may be sodium carboxymethyl cellulose or lithium carboxymethyl cellulose.

The second binder may be a water-based binder, for example, it may be one or more of styrene butadiene rubber, nitrile butadiene rubber, butadiene rubber, modified styrene butadiene rubber, sodium polyacrylate, water-based polyacrylonitrile copolymer or polyacrylate.

In some embodiments, a ratio of a thickness d1 of the first negative electrode film layer 200 to a thickness d2 of the second negative electrode film layer 300 may be in a range of 1:9-9:1. Exemplarily, a ratio of the thickness d1 of the first negative electrode film layer 200 to the thickness d2 of the second negative electrode film layer 300 may be 1:9, 5:5 or 9:1; the thickness d1 of the first negative electrode film layer 200 may be 44 μm; and the thickness d2 of the second negative electrode film layer 300 may be 56 μm.

An embodiment of the present disclosure further provides a lithium-ion battery including a positive electrode sheet, a negative electrode sheet, a separator and an electrolyte solution, in which the negative electrode sheet is the negative electrode sheet as described in above embodiments.

For the lithium-ion battery provided in this embodiment, the first negative electrode film layer 200 and the second negative electrode film layer 300 are disposed successively on the surface of the negative current collector 100, that is, the first negative electrode film layer 200 is attached to the surface of the negative current collector 100, and the second negative electrode film layer 300 is attached to the surface of the first negative electrode film layer 200. The active substance of the first negative electrode film layer 200 includes the silicon particle 220 and the first graphite particle 210, and the active substance of the second negative electrode film layer 300 includes the second graphite particle 310. That is, the negative electrode film layer is divided into two layers, where the active substance of the negative electrode film layer close to the negative current collector includes a mixture of the silicon particle 220 and the first graphite particle 210, and the active substance of another negative electrode film layer away from the negative current collector 100 includes the second graphite particle 310. Therefore, when the lithium-ions move to the negative electrode sheet, part of the lithium-ions are first embedded into the second graphite particles 310 in the second negative electrode film layer, and the remaining lithium-ions are embedded into the first negative electrode film layer. Since part of lithium-ions are embedded into the second negative electrode film layer 300 firstly, the concentration of lithium-ions moving to the first negative electrode film layer 200 is reduced, thereby reducing the accumulation of lithium-ions at the silicon particles and adjacent first graphite particles 210, and then relieving the phenomenon of uneven distribution of lithium-ion concentration, that is, reducing the lithium precipitation, and improving the endurance and service life of lithium-ion battery.

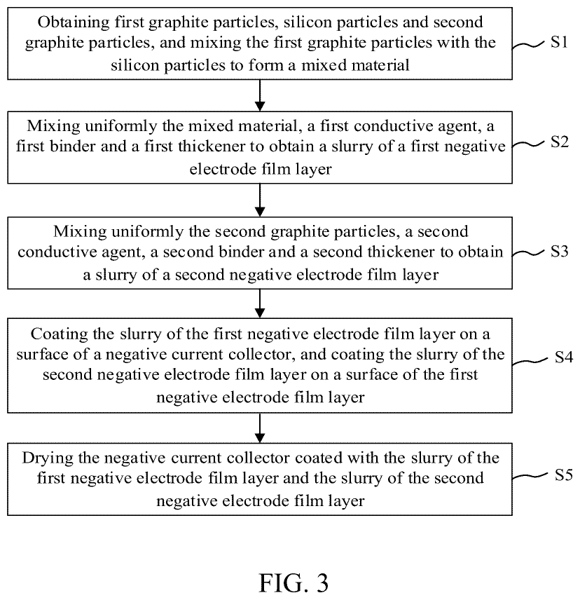

As shown in FIG. 3, an embodiment of the present disclosure further provides a method for preparing a negative electrode sheet, including,
S1: obtaining first graphite particles, silicon particles and second graphite particles, and mixing the first graphite particles with the silicon particles to form a mixed material;
S2: mixing uniformly the mixed material, a first conductive agent, a first binder and a first thickener to obtain a slurry of the first negative electrode film layer;
S3: mixing uniformly the second graphite particles, a second conductive agent, a second binder and a second thickener to obtain a slurry of the second negative electrode film layer;
S4: coating the slurry of the first negative electrode film layer on a surface of the negative current collector, and coating the slurry of the second negative electrode film layer on a surface of the first negative electrode film layer;
S5: drying the negative current collector coated with the slurry of the first negative electrode film layer and the slurry of the second negative electrode film layer.

It should be noted that the above preparation methods may be carried out in the above order, and the above order may also be exchanged according to actual needs.

Exemplarily, the obtaining first graphite particles, silicon particles and second graphite particles and mixing the first graphite particles with the silicon particles to form a mixed material, includes:
obtaining a certain amount of the same kind of graphite particles, and screening the graphite particles, where the graphite particles of the particle size less than a preset range act as the first graphite particles, and the remaining graphite particles act as the second graphite particles.

In order to better explain a negative electrode sheet, a lithium-ion battery, and a method for preparing the negative electrode sheet, and the following will provide a detailed explanation in combination with comparative examples and examples.

### Example 1

### I. Preparation of a Negative Electrode Sheet

### 1. Material Preparation

First graphite particles 210, silicon particles 220 and second graphite particles 310 are obtained, and the first graphite particles 210 are mixed with the silicon particles 220 to form a mixed material. Where, the steps of obtaining the first graphite particles 210, the silicon particles 220 and the second graphite particles 310, and mixing the first graphite particles 210 with the silicon particles 220 to form the mixed materials include:
obtaining graphite particles, screening the graphite particles, and using the graphite particles with a particle size less than a preset range as the first graphite particles 210, and the remaining graphite particles as the second graphite particles 310.

Exemplarily, a certain amount of graphite particles and silicon particles 220 are obtained, where a D10 particle size of the graphite particle is 5 μm, a D50 particle size of the graphite particle is 13 μm, and a D90 particle size of the graphite particle is 25 μm. The graphite particles of D10 are screened as the first graphite particles 210, and the remaining graphite particles, with the graphite particles of a particle size less than 7 μm being removed, act as the second graphite particles 310, that is, the particle size of the first graphite particle 210 may be in a range of 1-5 μm; and the particle size of the second graphite particle 310 may be in a range of 8-27 μm. Where, a D50 particle size of the silicon particle 220 is 8 μm and a D90 particle size of the silicon particle 220 is 20 μm.

The first graphite particles 210 and the silicon particles 220 are taken at a mass ratio of 95:5, and the two are mixed to obtain the mixed material 230.

### 2. Slurry Preparation

Preparation of the slurry of the first negative electrode film layer 200: the mixed material 230, the first conductive agent, the first binder and the first thickener are mixed uniformly to obtain the slurry of the first negative electrode film layer 200.

Exemplarily, the mixed material 230, the first conductive agent, the first binder and the first thickener are added to an agitating tank at a mass ratio of 96.9 wt %:0.5 wt %:1.3 wt %:1.3 wt %, and the slurry of the first negative electrode film layer 200 is prepared with deionized water. The above ratio is a mass ratio of dry material, and a solid content of the slurry is 42%. Meanwhile, in this example, the first conductive agent may be conductive carbon black, the first thickener may be sodium carboxymethyl cellulose, the first binder may be water-emulsion styrene butadiene rubber, and the first graphite particle 210 may be artificial graphite.

Preparation of the slurry of the second negative electrode film layer 300: the second graphite particles 310, the second conductive agent, the second binder and the second thickener are mixed uniformly to obtain the slurry of the second negative electrode film layer 300.

The second graphite particles 310, the second conductive agent, the second thickener and the second binder are added to an agitating tank at a mass ratio of 96.9 wt %:0.5 wt %:1.3 wt %:1.3 wt %, and the slurry of the second negative electrode film layer 300 is prepared with deionized water. The above ratio is a mass ratio of dry material, and the solid content of the slurry was 42%. Meanwhile, in this example, the second conductive agent may be conductive carbon black, the second thickener may be sodium carboxymethyl cellulose, the second binder may be water-emulsion styrene butadiene rubber, and the first graphite particle 210 may be artificial graphite.

### 3. Negative Electrode Sheet Preparation

The slurry of first negative electrode film layer 200 is coated on a surface of negative current collector 100, and the slurry of the second negative electrode film layer 300 is coated on a surface of the slurry of first negative electrode film layer 200; and the negative current collector 100 coated with the slurry of the first negative electrode film layer 200 and the slurry of the second negative electrode film layer 300 is dried.

Exemplarily, the slurry of the first negative electrode film layer 200 with silicon is coated on the surface of the negative current collector 100 by a coater, and the slurry of the second negative electrode film layer 300 of pure graphite particle without silicon is coated on the surface of the slurry of the first negative electrode film layer 200. Then, the negative electrode sheet is dried in a 5-section oven, where the temperatures of respective sections of oven are 60° C., 80° C., 110° C., 110° C., and 100° C., respectively. After drying, the thickness of the second negative electrode film layer 300 may be 55 μm, and the thickness of the first negative electrode film layer 200 may be 55 μm, so that a ratio of the thickness of the first negative electrode film layer 200 to a thickness of the second negative electrode film layer 300 is 5:5. The double-layer film layer on the other side of the negative current collector 100 is completed by repeated coating, so that the surfaces of both sides of the negative current collector 100 are both coated with a double-layer negative electrode film layer. A roller press is used for pressure treatment, so that the compaction density of the negative electrode sheet may be 1.75 g/cm², and the preparation of the negative electrode sheet is completed.

### II. Preparation of a Positive Electrode Plate

Using lithium cobaltate as a positive active material, the positive active material, a conductive agent and a thickener are added to an agitating tank at a mass ratio of 97.2:1.5:1.3; and NMP (N-methylpyrrolidone) solvent is added to stir fully, followed by subjecting the mixed slurry to pass through a sieve, and finally obtaining the positive electrode slurry. Where, the solid content of the positive electrode slurry is 70% to 75%; and then the slurry is coated on a positive current collector by a coater, in which the positive current collector may be an aluminum foil, and dried at 120° C., that is, the positive electrode sheet is obtained.

### III. Assembling of a Battery Cell

The above prepared negative electrode sheet and positive electrode sheet and a separator are wound together to form a rolled core, packaged with an aluminum-plastic film and baked to remove the water, followed by injecting an electrolyte solution, hot pressing, and performing formation, obtaining the battery cell.

### Example 2

This example differs from Example 1 in that: a ratio of the thickness of the first negative electrode film layer 200 to the thickness of the second negative electrode film layer 300 is 3:7.

### Example 3

This example differs from Example 1 in that: a ratio of the thickness of the first negative electrode film layer 200 to the thickness of the second negative electrode film layer 300 is 7:3.

### Example 4

This example differs from Example 1 in that: a mass ratio of the first graphite particles 210 to the silicon particles 220 is 90:10.

### Example 5

This example differs from Example 1 in that: in the first negative electrode film layer 200, a D50 particle size of the silicon particle 220 is 9 μm, and a D90 particle size of the silicon particle 220 is 22 μm.

### Example 6

This example differs from Example 1 in that: for the graphite particles, a D10 particle size is 3 μm, a D50 particle size is 11 μm, and a D90 particle size is 22 μm. That is, the graphite particles meeting D10 particle size are screened out and serve as the first graphite particles 210, the particle size of the first graphite particle 210 is not more than 3 μm, and the remaining graphite particles, where the particles less than 7 μm are removed, serve as the second graphite particles 310.

### Example 7

This example differs from Example 1 in that: for the graphite particles, a D10 particle size is 3 μm, a D50 particle size is 14 μm, and a D90 particle size is 28 μm. That is, the graphite particles meeting D10 particle size are screened out and serve as the first graphite particles 210, the particle size of the first graphite particles 210 is not more than 3 μm, and the remaining graphite particles, where the particles less than 7 μm are removed, serve as the second graphite particles 310.

### Comparative Example 1

This example differs from Example 1 in that: the negative electrode film layer is a one-layer structure, that is, the active substance includes the silicon particle 220 and graphite particle, which are mixed and coated on the negative current collector 100 to form a negative electrode sheet with a single-layer negative electrode film layer.

### Comparative Example 2

This example differs from Example 1 in that: the graphite particles are not screened. That is, part of the graphite particles directly serves as the first graphite particles 210 and the remaining graphite particles serve as the second graphite particles 310. In other words, in this example, the graphite particles with small particle size are not screened as the first graphite particles 210 in the first negative electrode film layer 200, and the graphite particles with large particle size are not used as the second graphite particles 310 in the second negative electrode film layer 300. Where, for the graphite particles, a D10 particle size is 5 μm, a D50 particle size is 13 μm, a D90 particle size is 25 μm; and for the silicon particles 220, a D50 particle size is 8 μm, a D90 particle size is 20 μm.

Each battery cell prepared above is subjected to 1.2 C stepped charging/0.7 C discharging at 25° C., and the battery is disassembled under different numbers of cycles to confirm the lithium precipitation situation on the surface of the negative electrode sheet of the battery. The disassembly results and the energy density are as follows.

Table 1 gives a table of the main relevant parameters for Examples 1-7 and Comparative examples 1-2

| | | 500T Lithium | | |
|---|---|---|---|---|
| | | precipitation | | |
| | | situation on the | 700T | |
| | Energy | surface of the | Capacity | 700T |
| | density | negative electrode | retention | Expansion |
| Item | (wh/L) | sheet | rate/% | rate/% |
| Example 1 | 817 | 0 | 82.57 | 9.58 |
| Example 2 | 815 | 0 | 86.09 | 9.29 |
| Example 3 | 819 | 1 | 81.7 | 10.21 |
| Example 4 | 821 | 1 | 79.52 | 10.09 |
| Example 5 | 822 | 0 | 80.03 | 10.62 |
| Example 6 | 816 | 0 | 84.77 | 9.56 |
| Example 7 | 823 | 0 | 77.27 | 11.77 |
| Comparative | 820 | 5 | 65.32 | 17.65 |
| example 1 | | | | |
| Comparative | 815 | 4 | 69.17 | 15.31 |
| example 2 | | | | |

In this Table 1, the degree of lithium precipitation on the surface of the negative electrode sheet is expressed by 0, 1, 2, 3, 4, and 5, where 0 represents no lithium precipitation; 5 represents serious lithium precipitation; 1, 2, 3, and 4 represent different degrees of lithium precipitation; and the larger the number, the more serious the degree of lithium precipitation.

As can be seen from Table 1, Examples 1 to 3 show the influence of different thicknesses between the first negative electrode film layer 200 and the second negative electrode film layer 300 on the lithium precipitation of the negative electrode sheet. That is, in the case that the ratio of the thickness of the first negative electrode film layer 200 to the thickness of the second negative electrode film layer 300 is 5:5 and 3:7 respectively, after the lithium-ion battery is subjected to charging and discharging for 500 T (cycle), no lithium is precipitated on the surface of the negative electrode sheet; in the case that the ratio of the thickness of the first negative electrode film layer 200 to the thickness of the second negative electrode film layer 300 reaches 7:3, after the lithium-ion battery is subjected to charging and discharging for 500 T (cycle), the degree of lithium precipitation on the surface of the negative electrode sheet is 1.

At the same time, it can also be seen that the ratio of the thickness of the first negative electrode film layer 200 to the thickness of the second negative electrode film layer 300 has a certain influence on the battery capacity retention rate and the expansion rate. When the ratios of the thickness of the first negative electrode film layer 200 to the thickness of the second negative electrode film layer 300 are 5:5, 3:7 and 7:3 respectively, after the lithium-ion battery is subjected to charging and discharging for 700 T (cycle), the capacity retention rates of the lithium-ion battery are 82.57%, 86.09% and 81.7%, respectively; after the lithium-ion battery is subjected to charging and discharging for 700 T (cycle), the expansion rates of lithium-ion battery are 9.58%, 9.29%, and 10.21%, respectively, and its energy densities are 817 wh/L, 815 wh/L and 819 wh/L, respectively.

It can be seen from the above that the negative electrode film layer is divided into two layers, the second negative electrode film layer 300 with the active substance being the pure graphite particle is disposed at an outer layer, and the first negative electrode film layer 200 with the active substance being the mixture of graphite particle and silicon particle 220 is disposed at the inner layer. In this way, when the lithium-ions move to the negative electrode sheet, part of the lithium-ions are first embedded into the graphite particles in the second negative electrode film layer 300, and the remaining lithium-ions are embedded into the first negative electrode film layer 200. Since the part of lithium-ions are first embedded into the second negative electrode film layer 300, the concentration of lithium-ions moving to the first negative electrode film layer 200 is reduced and the speed of them becomes slow, which allows enough time for lithium-ions to embed into the silicon particles and the first graphite particles, thus reducing the accumulation density of lithium-ions at the silicon particles 220 and the first graphite particles 210 in their vicinity, and then relieving the phenomenon of uneven distribution of lithium-ion concentration, that is, reducing the lithium precipitation, thereby improving the endurance and service life of lithium-ion battery. With the increase of the thickness of the first negative electrode film layer 200, the energy density of lithium-ion battery does not change much. However, when the first negative electrode film layer 200 is thicker, that is, when the second negative electrode film layer 300 is thinner, the content of lithium-ions embedded into the second negative electrode film layer 300 is reduced, causing more lithium-ions to get embedded into the first negative electrode film layer 200, thereby increasing the accumulation density of lithium-ions at silicon particles 220 and their vicinity, which results in the precipitation of lithium-ions. At the same time, with the increase of the thickness of the first negative electrode film layer 200, that is, the increase of the content of silicon particles 220 in the negative electrode sheet, the capacity retention rate of the lithium-ion battery can be gradually increased. At the same time, with the increase of the thickness of the first negative electrode film layer 200, that is, the increase of the content of silicon particles 220 in the negative electrode sheet, the expansion rate of the lithium-ion battery will also increase. Therefore, when selecting the thickness of the first negative electrode film layer 200 and the thickness of the second negative electrode film layer 300, comprehensive consideration is needed to obtain a lithium-ion battery with excellent overall performance.

It can be seen from Examples 1 and 4 that when the ratio of the content of silicon particles 220 to the content of first graphite particles 210 in the first negative electrode film layer 200 reaches 10:90, after the lithium-ion battery is subjected to charging and discharging for 500 T (cycle), the degree of lithium precipitation on the surface of the negative electrode sheet is 1; after the lithium-ion battery is subjected to charging and discharging for 700 T (cycle), the capacity retention rate of lithium-ion battery is 79.52%; after the lithium-ion battery is subjected to charging and discharging for 700 T (cycle), the expansion rate of lithium-ion battery is 10.09%, and the energy density is 821 wh/L.

It can be seen that when the content of silicon particles 220 is larger, although the energy density remains basically unchanged, it will increase the degree of lithium precipitation on the surface of the negative electrode sheet, meanwhile, it can also reduce the capacity retention rate of lithium-ion battery, and increase the expansion rate of lithium-ion battery. Therefore, the selection of an appropriate amount of silicon particles 220 can effectively improve the comprehensive performance of the lithium-ion battery.

It can be seen from Examples 1 and 5 that when the particle size of the silicon particles 220 in the first negative electrode film layer 200 is larger, that is, the D50 particle size of the silicon particles 220 reaches 9 μm and the D90 particle size of the silicon particles 220 reaches 22 μm, after the lithium-ion battery is subjected to charging and discharging for 500 T (cycle), the degree of the lithium precipitation on the surface of the negative electrode sheet is 0. After the lithium-ion battery is subjected to charging and discharging for 700 T (cycle), the capacity retention rate of the lithium-ion battery is 80.03%; after the lithium-ion battery is subjected to charging and discharging for 700 T (cycle), the expansion rate of the lithium-ion battery is 10.62%.

It can be seen that when the silicon particle 220 particle is larger, the capacity retention rate of the lithium-ion battery will be reduced, and the expansion rate of the lithium-ion battery can be increased. The reason is that the larger the particle size of the silicon particle 220, the worse the dynamic performance of the silicon particle 220, and the easier it is for the volume of the silicon particle 220 to expand. Therefore, the selection of silicon particles 220 with a reasonable particle size can effectively improve the comprehensive performance of lithium-ion battery.

It can be seen from Examples 1 and 6 that when the particle size of graphite particles in the first negative electrode film layer 200 is smaller, that is, the D10 particle size of graphite particles reaches 3 μm, the D50 particle size of graphite particles reaches 11 μm, and the D90 particle size of graphite particles reaches 22 μm, namely, the particle sizes of the first graphite particles 210 and the second graphite particles 310 decrease correspondingly. However, when the particle size of the second graphite particles 310 is still much larger than the particle size of the first graphite particles 210, after the lithium-ion battery is subjected to charging and discharging for 500 T (cycle), the degree of the lithium precipitation on the surface of the negative electrode sheet is 0. After the lithium-ion battery is subjected to charging and discharging for 700 T (cycle), the capacity retention rate of lithium-ion battery is 84.77%; and after the lithium-ion battery is subjected to charging and discharging for 700 T (cycle), the expansion rate of lithium-ion battery is 9.56%, and the energy density is 816 wh/L.

It can be seen that when the particle size of the first graphite particles 210 and the particle size of the second graphite particles 310 are both appropriately reduced, there is no significant change in the energy density, lithium precipitation situation and volume expansion rate of the lithium-ion battery, but there is a certain rise in the capacity retention rate of the lithium-ion battery. Therefore, reducing the particle size of the graphite particles appropriately can improve the capacity retention rate of the lithium-ion battery under the premise of keeping its energy density, lithium precipitation situation and volume expansion rate basically unchanged.

It can be seen from Examples 1 and 7 that when the particle size of graphite particles in the second negative electrode film layer 300 is larger, that is, when the D50 particle size of graphite particles reaches 14 μm and the D90 particle size of graphite particles reaches 28 μm, after the lithium-ion battery is subjected to charging and discharging for 500 T (cycle), the degree of lithium precipitation on the surface of the negative electrode sheet is 0. After the lithium-ion battery is subjected to charging and discharging for 700 T (cycle), the capacity retention rate of lithium-ion battery is 77.27%; after the lithium-ion battery is subjected to charging and discharging for 700 T (cycle), the expansion rate of lithium-ion battery is 11.77%, the energy density is 823 wh/L.

It can be seen that when the particle size of the graphite particles in the second negative electrode film layer 300 is larger, although the energy density of the lithium-ion battery increases, the capacity retention rate of the lithium-ion battery shows a relatively significant downward trend, and the volume expansion rate also shows a relatively significant increasing trend. Therefore, although the second graphite particles 310 in the second negative electrode film layer 300 have a larger particle size, they can improve the porosity of the negative electrode sheet compared with small particles, thereby improving the liquid retention of the battery cell, reducing the surface polarization of the negative electrode sheet, improving the dynamic performance of the negative electrode sheet, and further increasing the endurance and service life of lithium-ion battery. However, when the particle size of the graphite particles in the second negative electrode film layer 300 is too large, it will lead to a significant reduction in the number of graphite particles in the second negative electrode film layer 300, resulting in a significant reduction in the amount of lithium-ions embedded into the second negative electrode film layer 300, accumulation of more lithium-ions near the silicon particles 220, thereby affecting the capacity retention rate and expansion rate of lithium-ion battery.

From the Comparative example 1, it can be seen that when the slurry of mixed silicon particles 220 and graphite particles is coated on the negative current collector to form a negative electrode film layer, after the lithium-ion battery is subjected to charging and discharging for 500 T (cycle), the degree of lithium precipitation on the surface of the negative electrode sheet is 5; after the lithium-ion battery is subjected to charging and discharging for 700 T (cycle), the capacity retention rate of lithium-ion battery is 65.32%; and after the lithium-ion battery is subjected to charging and discharging for 700 T (cycle), the expansion rate of lithium-ion battery is 17.65%, and its energy density is 820 wh/L.

Thus, by comparing Examples 1 to 7 with Comparative example 1, it can be seen that using the structure of examples of the present disclosure can effectively reduce the degree of lithium-ion precipitation, significantly improve the capacity retention rate of lithium-ion battery, and reduce the expansion rate of lithium-ion battery.

From the Comparative example 2, it can be seen that when the graphite particles are not screened, that is, part of the graphite particles directly acts as the first graphite particles 210, and the remaining graphite particles act as the second graphite particles 310, after the lithium-ion battery is subjected to charging and discharging for 500 T (cycle), the degree of lithium precipitation on the surface of the negative electrode sheet is 4; after the lithium-ion battery is subjected to charging and discharging for 700 T (cycle), the capacity retention rate of lithium-ion battery is 69.32%; and after the lithium-ion battery is subjected to charging and discharging for 700 T (cycle), the expansion rate of lithium-ion battery is 15.31%, and its energy density is 815 wh/L.

Therefore, compared with Comparative examples 2 and 1, it can be seen that although the comprehensive performance of lithium-ion battery can be improved to a certain extent by dividing the negative electrode film layer into two layers, the lithium precipitation situation is still relatively serious, meanwhile the capacity retention rate of lithium-ion battery is still lower, and the expansion rate of lithium-ion battery is larger.

Further, by comparing Examples 1 to 7 with Comparative example 2, it can be seen that using the structure of embodiments of the present disclosure can effectively reduce the degree of lithium-ion precipitation, significantly improve the capacity retention rate of lithium-ion battery, and reduce the expansion rate of lithium-ion battery. That is, selecting the graphite particles in the first negative electrode film layer 200 to have a smaller particle size, can make the periphery of the silicon particle 220 be wrapped completely with the graphite particles, thereby being capable of effectively improving the overall dynamic performance of the lithium-ion battery, reducing the degree of lithium-ion precipitation, significantly increasing the capacity retention rate of the lithium-ion battery, and reducing the expansion rate of the lithium-ion battery.

In the description of embodiments of the present disclosure, it is to be understood that the orientation or position relationship indicated by the terms “center”, “longitudinal”, “transverse”, “length”, “width”, “thickness”, “up”, “down” etc. is based on the orientation or position relationship shown in the accompanying drawings and only to facilitate the description of embodiments of the present disclosure and simplify the description, and rather than indicating or implying that the device or component referred to must have a specific orientation or be constructed and operated in a specific orientation, and therefore cannot be interpreted as a limitation to embodiments of the present disclosure.

In addition, the terms “first” and “second” are only used for the purpose of description, and should not be understood as indicating or implying relative importance, or implicitly specifying the number of the indicated technical features. Therefore, the features defined by “first”, “second” and “third” may explicitly or implicitly include at least one of the features. In the description of embodiments of the present disclosure, the meaning of “more” is at least two, such as two, three, etc., unless otherwise expressly and specifically limited.

In embodiments of the present disclosure, unless otherwise expressly specified and limited, the terms “mounted”, “linked”, “connected”, “fixed”, etc. shall be understood in a broad sense. For example, it may be fixed connection, detachable connection, or integrated connection; mechanical connection, or electric connection; direct connection, indirect connection by an intermediate medium, the communication between the interiors of two components, or an interaction relationship between two components, unless otherwise expressly limited. For persons of ordinary skill in the art, the specific meanings of the aforesaid terms in embodiments of the present disclosure may be understood based on specific situations.

In embodiments of the present disclosure, unless otherwise expressly specified and limited, the first feature “above” or “below” the second feature may mean a direct contact between the first and second features, or an indirect contact between the first and second features through an intermediate medium. Moreover, the first feature being “above”, “over” and “on” the second feature may mean that the first feature is directly above or diagonally above the second feature, or simply indicates that the first feature is higher than the second feature in a horizontal height. The first feature “below”, “under”, and “beneath” the second feature may mean that the first feature is directly below or diagonally below the second feature, or simply indicates that the first feature is below than the second feature in a horizontal height.

In the description of this specification, reference to the description of the terms “an embodiment”, “some embodiments”, “examples”, “specific examples”, or “some examples”, etc. means that specific features, structures, materials, or characteristics described in conjunction with this embodiment or example are included in at least one embodiment or example of the embodiments of the present disclosure. In this specification, the schematic description of the aforesaid terms needs not be directed to the same embodiment or example. Moreover, the specific features, structures, materials or characteristics described may be combined in a suitable manner in any one or more embodiments or examples. In addition, without contradicting with each other, persons of ordinary skill in the art may integrate and combine different embodiments or examples and characteristics of different embodiments or examples described in this specification.

Notwithstanding that embodiments of the present disclosure have been shown and described above, it may be understood that the aforesaid embodiments are exemplary and cannot be construed as a limitation of embodiments of the present disclosure, and persons of ordinary skill in the art may alter, change, replace, and modify the aforesaid embodiments within the scope of embodiments of the present disclosure.

What is claimed is:

1. A negative electrode sheet, comprising:
a negative current collector;
a first negative electrode film layer attached to a surface of the negative current collector, an active substance of the first negative electrode film layer comprising silicon particles and first graphite particles;
a second negative electrode film layer attached to a surface of the first negative electrode film layer, an active substance of the second negative electrode film layer comprising second graphite particles, and a particle size of the second graphite particle being greater than a particle size of the first graphite particle.

2. The negative electrode sheet according to claim 1, wherein the particle size of the first graphite particle is smaller than a particle size of the silicon particle.

3. The negative electrode sheet according to claim 1, wherein an outer wall of the silicon particle is wrapped with the first graphite particles.

4. The negative electrode sheet according to claim 1, wherein a ratio of a D90 particle size of the first graphite particle to a D90 particle size of the silicon particle is 0.2-0.5.

5. The negative electrode sheet according to claim 1, wherein the first graphite particle and the second graphite particle are derived from a same type of graphite.

6. The negative electrode sheet according to claim 1, wherein in the first negative electrode film layer, a D50 particle size of the silicon particle is 6 μm-10 μm, and a D90 particle size of the silicon particle is 18 μm-22 μm; a D50 particle size of the first graphite particle is 2 μm-4.5 μm, and a D90 particle size of the first graphite particle is 4.7 μm-6 μm.

7. The negative electrode sheet according to claim 1, wherein in the second negative electrode film layer, a D50 particle size of the second graphite particle is 11 μm-14 μm, and a D90 particle size of the second graphite particle is 22 μm-29 μm.

8. The negative electrode sheet according to claim 7, wherein the particle sizes of the second graphite particles are each greater than 7 μm.

9. The negative electrode sheet according to claim 1, wherein a content of the silicon particles in the first negative electrode film layer is 0.1%-30%.

10. The negative electrode sheet according to claim 1, wherein the first negative electrode film layer further comprises a first conductive agent, a first binder and a first thickener; and in the first negative electrode film layer, a mass ratio of a mixed material of the silicon particles and the first graphite particles is 75 wt %-99 wt %.

11. The negative electrode sheet according to claim 10, wherein a mass ratio of the first conductive agent is 0.1 wt %-5 wt %, a mass ratio of the first binder is 0.1 wt %-5 wt %, and a mass ratio of the first thickener is 0.5 wt %-5 wt %.

12. The negative electrode sheet according to claim 1, wherein the second negative electrode film layer further comprises a second conductive agent, a second binder and a second thickener; and in the second negative electrode film layer, a mass ratio of the second graphite particles is 75 wt %-99 wt %.

13. The negative electrode sheet according to claim 12, wherein a mass ratio of the second conductive agent is 0.1 wt %-5 wt %, a mass ratio of the second binder is 0.1 wt %-5 wt %, and a mass ratio of the second thickener is 0.5 wt %-5 wt %.

14. The negative electrode sheet according to claim 1, wherein a ratio of a thickness of the first negative electrode film layer to a thickness of the second negative electrode film layer is 1:9-9:1.

15. A lithium-ion battery, comprising a positive electrode sheet, a negative electrode sheet, a separator and an electrolyte solution, wherein the negative electrode sheet is the negative electrode sheet according to claim 1.
